(19) United States
(12) Patent Application Publication
(10) Pub. No.: US 2020/0314251 A1
(43) Pub. Date: Oct. 1, 2020

(54) IMAGE FORMING APPARATUS AND METHOD

(71) Applicant: CANON KABUSHIKI KAISHA, Tokyo (JP)

(72) Inventor: Norihiko Kobayashi, Fujisawa-shi (JP)

(21) Appl. No.: 16/820,399

(22) Filed: Mar. 16, 2020

(30) Foreign Application Priority Data
Mar. 26, 2019 (JP) 2019-058732

(51) Int. Cl. H04N 1/00

(52) U.S. Cl. CPC H04N 1/00015; H04N 1/00076; H04N 1/00408

(57) ABSTRACT

An image forming apparatus includes a display unit, a processor, and a memory to perform an operation including displaying, in the display unit, a screen including a message for prompting removal of a sheet remaining in a paper path of the image forming apparatus. When the screen is displayed in a case where diagnosis processing is required on a detected abnormality, the screen does not include an instruction portion that allows the screen to be closed without removing the sheet. When the screen is displayed in a case where the diagnosis processing is not required, the screen includes the instruction portion that allows the screen to be closed without removing the sheet. The performed operations also include performing the diagnosis processing, in response to a detection of removal of a sheet remaining in a paper path of the image forming apparatus in the case where the diagnosis processing is required.

### BACKGROUND

### Field

The present disclosure relates to an image forming apparatus such as a copier or a printer and, more particularly, to user interface (UI) control in a case where, when a malfunction occurs in the apparatus, the image forming apparatus makes a self-diagnosis of a fault to identify a location where the fault occurs.

### Description of the Related Art

According to a conventional technology, an image forming apparatus with a print function is provided which is capable of making a self-diagnosis in response to an error (abnormality) occurring in a hardware device during a job execution (Japanese Patent Application Laid-Open No. 2015-131415).

When a fault diagnosis is made when an error occurs, it is sometimes necessary to remove a sheet of paper remaining, due to a paper jam or the like, in a paper path through which the paper passes within the apparatus.

Usually, the image forming apparatus is capable of performing processing such as scan transmission without using paper even if a user does not remove the paper; therefore, the apparatus may be left while no action of the fault diagnosis is taken. Even if notification is given to prompt the user to remove the paper, he/she possibly cannot determine whether the notification is jam notification involving a fault diagnosis or normal jam notification.

As a consequence, there is a concern that a self-diagnosis is not made quickly which is necessary for effective maintenance such as identifying a location where the fault has occurred.

### SUMMARY

According to an aspect of the present disclosure, an image forming apparatus includes a display unit, a processor and a memory storing instructions that, when the instructions are executed by the processor, cause the image forming apparatus to perform operations including: displaying, in the display unit, a screen including a message for prompting removal of a sheet remaining in a paper path of the image forming apparatus, wherein, when the screen is displayed in a case where diagnosis processing is required on a detected abnormality, the screen does not include an instruction portion that allows the screen to be closed without removing the sheet, and wherein, when the screen is displayed in a case where the diagnosis processing is not required, the screen includes the instruction portion that allows the screen to be closed without removing the sheet, and performing the diagnosis processing, in response to a detection of removal of a sheet remaining in a paper path of the image forming apparatus in the case where the diagnosis processing is required.

Further features of the present disclosure will become apparent from the following description of exemplary embodiments with reference to the attached drawings.

### BRIEF DESCRIPTION OF THE DRAWINGS

FIG. 1 is a diagram showing an example of the overall configuration of a system.

FIG. 2 is a block diagram showing an example of a multifunction peripheral.

FIG. 3 is a diagram showing an example of the hardware configuration of an information processing controller unit and a printer controller unit.

FIG. 4 is a diagram showing an example of the software configuration of a multifunction peripheral.

FIG. 5 is a diagram showing an example of a unit code generated in a fault diagnosis module.

FIG. 6 is a flowchart illustrating an example of print processing according to an exemplary embodiment.

FIG. 7A is a flowchart illustrating an example of print processing by a printer controller unit.

FIG. 7B is a flowchart illustrating an example of fault diagnosis processing by a printer controller unit.

FIG. 8 is a flowchart illustrating an example of event reception processing in an execution processing module.

FIGS. 9A to 9C illustrate examples of user interface (UI) display according to an exemplary embodiment.

FIG. 10 is a flowchart illustrating an example of print processing and fault diagnosis processing according to another exemplary embodiment.

FIGS. 11A to 11C illustrate examples of UI display according to another exemplary embodiment.

FIG. 12 is a flowchart illustrating an example of event reception processing in an execution processing module according to another exemplary embodiment.

### DESCRIPTION OF THE EMBODIMENTS

Exemplary embodiments for describing modes for carrying out the present disclosure are described below with reference to the drawings.

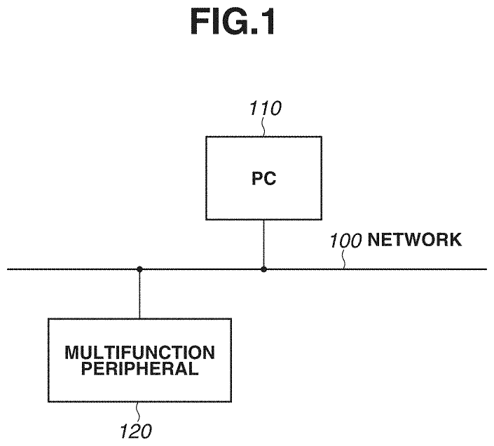

The first exemplary embodiment is hereinafter described. FIG. 1 is a diagram showing an example of the overall configuration of a system according to the present exemplary embodiment. A personal computer (PC) 110 and a multifunction peripheral (MFP) 120 are connected to a network 100.

The PC 110 sends print data and so on via the network 100 to the multifunction peripheral 120. The multifunction peripheral 120 is a device for implementing a plurality of functions, e.g., copying, printing, scanning, and faxing. The multifunction peripheral 120 has, therein, a function of keeping a history of execution of the plurality of functions and a function of keeping a record of the occurrence of an error (abnormality) or an alarm. The multifunction peripheral 120 is detailed below. The below description takes an example of a multifunction peripheral; however, it is only required that the apparatus is an image forming apparatus for conveying a sheet to perform image processing, and the apparatus may be a single-function printer having a print function, a single-function scanner having a scan function, or the like.

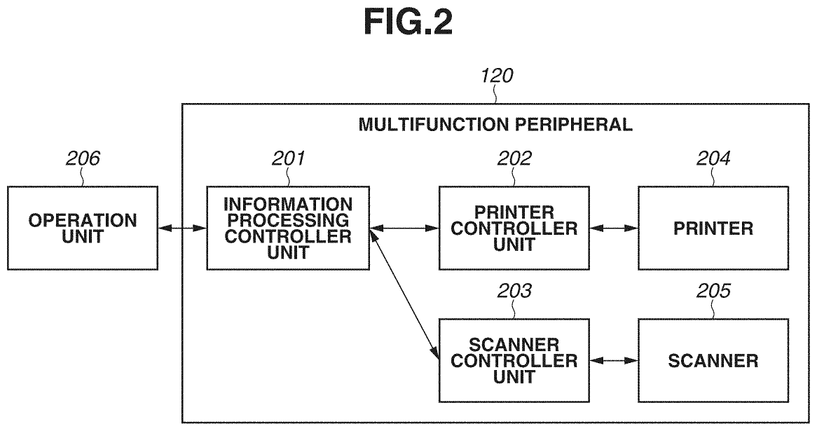

FIG. 2 is a block diagram showing an example of the configuration of the multifunction peripheral 120 according to the present exemplary embodiment. The multifunction peripheral 120 includes an information processing controller unit 201, a printer controller unit 202, a scanner controller unit 203, a printer 204, a scanner 205, and an operation unit 206. The information processing controller unit 201 is a controller that supervises information processing control related to operation of the multifunction peripheral 120, and is connected to the operation unit 206. The information processing controller unit 201 is also connected to the printer controller unit 202 for controlling the printer 204 that is an image output device and to the scanner controller unit 203 for controlling the scanner 205 that is an image input device.

Hardware Configuration

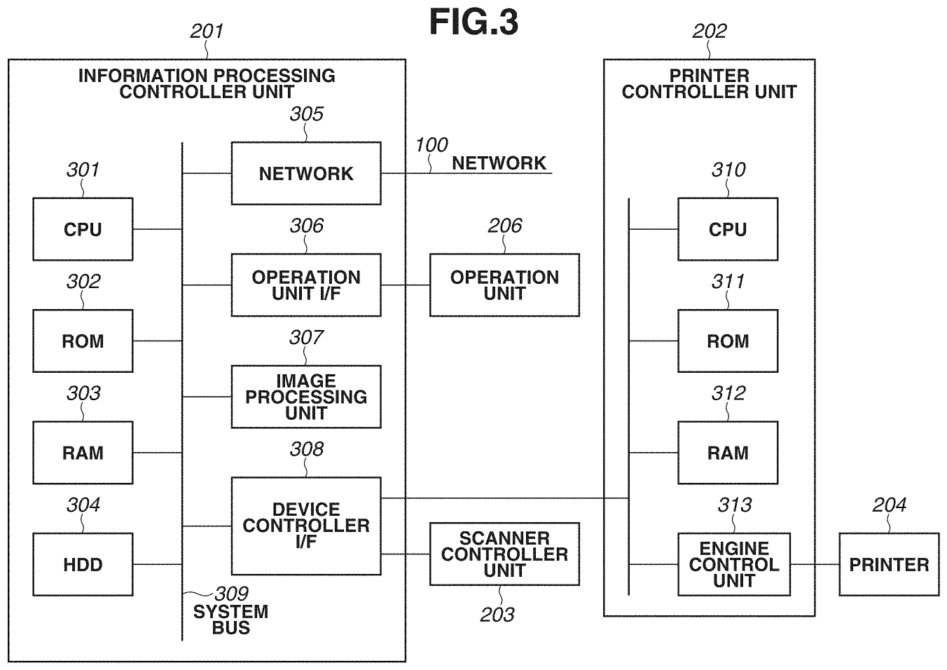

FIG. 3 is a block diagram showing an example of the hardware configuration of the information processing controller unit 201 and the printer controller unit 202 of the multifunction peripheral 120 according to the present exemplary embodiment.

### (Information Processing Controller Unit)

The information processing controller unit 201 includes a central processing unit (CPU) 301 which starts an operating system (OS) with a boot program stored in a read-only memory (ROM) 302. The ROM 302 includes a flash memory such as an embedded multimedia card (eMMC) and a controller thereof, and serves to store a control program of the CPU 301. The CPU 301 executes, on the OS, an application program stored in the ROM 302 or a hard disk drive (HDD) 304 to perform various processing. As a work area of the CPU 301, a random-access memory (RAM) 303 is used. Further, in addition to the work area, the RAM 303 provides an image memory area for temporarily storing image data. The ROM 302 or the HDD 304 stores the application program, image data, and various setting values. The HDD 304 may not be built-in in some cases.

The CPU 301 is connected to, an operation unit interface (I/F) 306, a device controller I/F 308, a network 305, and an image processing unit 307 as well as to the ROM 302 and the RAM 303 via a system bus 309.

The operation unit I/F 306 is an interface with the operation unit 206 having a touch panel. The operation unit I/F 306 outputs, to the operation unit 206, image data to be displayed in a display unit of the operation unit 206. The operation unit I/F 306 also sends, to the CPU 301, information entered by a user using the operation unit 206.

The device controller I/F 308 is connected to the scanner controller unit 203 and the printer controller unit 202, and the device controller I/F 308 performs synchronous conversion and asynchronous conversion on image data.

The network 305 is connected to the network 100, and inputs and outputs information, via the network 100, from/to the individual devices on the network 100.

The image processing unit 307 performs processing for outputting an image to the printer 204, processing for inputting an image from the scanner 205, image rotation, image compression, resolution conversion, color space conversion, gradation conversion, and so on.

### (Printer Controller Unit)

The printer controller unit 202 is connected to the printer 204 having, for example, an electrophotographic printer engine. An engine control unit 313 controls the printer engine to carry out printing in accordance with image data received via the device controller I/F 308 from the information processing controller unit 201.

The printer controller unit 202 includes a CPU 310, and the CPU 310 executes a program stored in a ROM 311, uses a RAM 312 as a work memory to control the printer 204.

Software Configuration

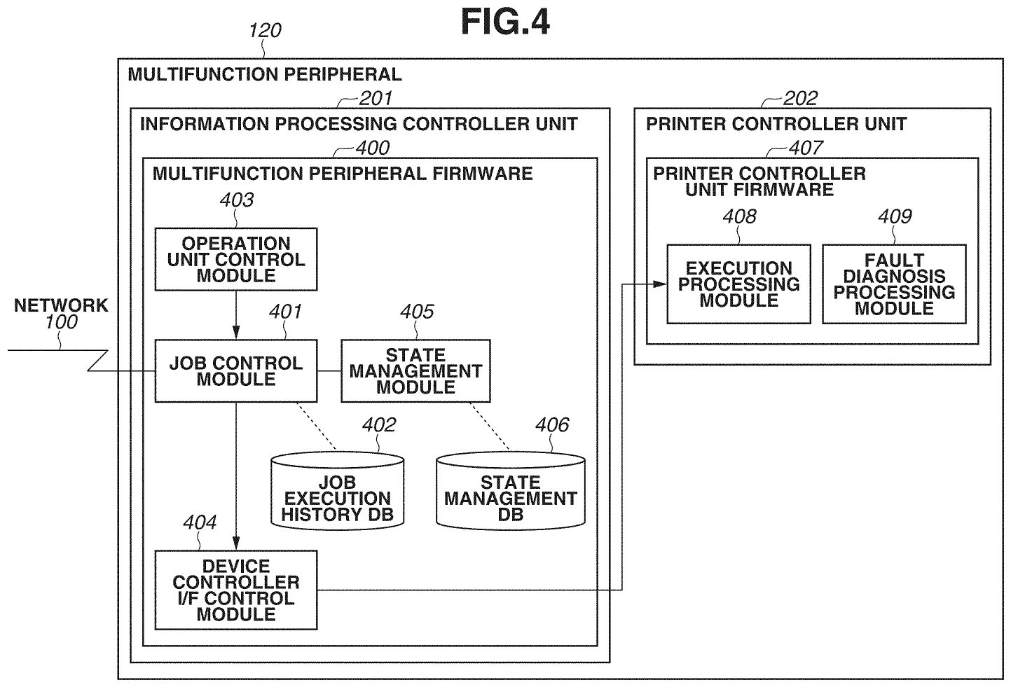

FIG. 4 is a bock diagram showing an example of the software configuration of multifunction peripheral firmware 400 and the software configuration of printer controller unit firmware 407 operating in the multifunction peripheral 120 according to the present exemplary embodiment.

### (Multifunction Peripheral Firmware)

The multifunction peripheral firmware 400 is stored in a storage unit of any one of the ROM 302, the RAM 303, and the HDD 304. When being executed by the CPU 301, the multifunction peripheral firmware 400 functions.

A job control module 401 is connected via the network 305 to the network 100. The job control module 401 receives a job such as printing with a specific communication protocol, and executes a job such as copying, printing, or scanning. At the time, the job control module 401 saves a job execution history in a job execution history database (DB) 402. In addition, the job control module 401 is capable of returning job-related data in response to an inquiry from another module, and of receiving an event purchase request to convey an event at a time of a state change of a job. For example, the event can be conveyed at a time when a job starts, stops, or ends. The job execution history DB 402 stores, therein, a job execution history which includes information associated with job execution such as an execution start date and time, an execution end date and time, the number of fed sheets of paper, the number of ejected sheets of paper, and the presence/absence of stapling; however, the job execution history may include other contents. The job execution history stored in the job execution history DB 402 is stored in the HDD 304. An operation unit control module 403 receives user operation for giving a command to execute a job such as copying or scanning from the operation unit 206 via the operation unit I/F 306 to notify the job control module 401.

A device controller I/F control module 404 is a module that receives image data to be processed and control data from the job control module 401 to control the printer controller unit 202 and the scanner controller unit 203. The device controller I/F control module 404 also receives, from the printer controller unit 202 and the scanner controller unit 203, usage information, sensor values, and fault-related information about parts installed in the printer 204 and the scanner 205.

A state management module 405 is a module that manages a state of the multifunction peripheral 120. The state management module 405 serves to manage an error code or an alarm code given in notification, for example, by the printer 204 and the scanner 205 connected to the multifunction peripheral 120. The error code is a code that indicates an error cause at a time when the operation of the multifunction peripheral 120 stops or degenerates. The alarm code is a code that indicates the occurrence of an abnormality in the apparatus although the operation of the multifunction peripheral 120 does not stop or degenerate. The state management module 405 records, in the state management DB 406, information concerning an error (abnormality) or an alarm given by the job control module 401 and the like.

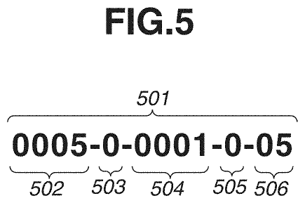

When an error (abnormality) occurs in the printer controller unit 202 or the scanner controller unit 203, the state management module 405 also records, in the state management DB 406, a unit code calculated in a fault diagnosis processing module 409 of the printer controller unit 202 or the scanner controller unit 203. The unit code is information including a location where a fault has occurred, which is identified as a result of execution of a fault diagnosis program and an action method for recovering from the fault, and the unit code is detailed below with reference to FIG. 5. In a case where the fault and so on do not allow a hardware part of the printer 204 or the scanner 205 to operate, the state management module 405 also manages a degenerate state where the hardware part having an issue is stopped and only the other functions are used.

### (Printer Controller Unit Firmware)

The printer controller unit firmware 407 is stored in a storage unit of either one of the ROM 311 and the RAM 312. When executed by the CPU 310, the printer controller unit firmware 407 functions.

An execution processing module 408 executes print processing on the basis of a print processing request sent from the device controller I/F control module 404. When the occurrence of an error is detected in the print processing, the execution processing module 408 requests the fault diagnosis processing module 409 to make a fault diagnosis.

The fault diagnosis processing module 409 performs fault diagnosis processing on the basis of a code of an error which has occurred in the print processing executed in the execution processing module 408. Further, the fault diagnosis processing module 409 serves to identify a location of the fault which has caused an error as a result of the fault diagnosis, and to calculate a unit code including an action method for recovering the fault area.

### (Unit Code)

FIG. 5 shows an example of a unit code according to the present exemplary embodiment.

FIG. 5 shows a unit code 501. The unit code is information about a location where a fault occurs identified as a result of execution of a fault diagnosis program and a method as to the action for recovering from the fault. The individual codes included in the unit code will be described.

A part code 502 represents a unit corresponding to a faulty part, of the multifunction peripheral 120, which has caused an error identified in the result of the fault diagnosis. Examples of the unit include the information processing controller unit 201, the HDD, a fixing unit, a drum unit, a developing unit, and an intermediate transfer belt (ITB) unit included in the multifunction peripheral 120.

In a case where the unit has a sub-unit, sub-unit information 503 may be added. As the sub-unit information, in the case of a toner cartridge for example, Y, M, C, and K can be defined as the sub-unit information.

A part detailed code 504 represents a sub-component part in the unit. As to the fixing unit, for example, the part detailed code 504 represents the unit itself, a fixing film, a pressure roller, and so on.

An action information code 505 represents information about measures necessary to take against the faulty unit or the sub-component identified in the result of the fault diagnosis. Examples of the action method include a code indicating the need for replacement, a code indicating a high possibility of fault, a code indicating the need for cleaning, and a code indicating the need for adjustment.

An occurrence section code 506 is information that indicates a fault occurrence section and is used to identify a place where the unit is installed.

Entire Flow of Print Processing (Information Processing Controller)

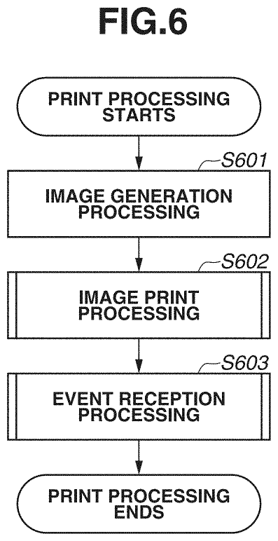

The flow of processing performed within the information processing controller unit 201 will be discussed with reference to FIG. 6 in a case where the multifunction peripheral 120 starts print processing, an error is detected in the printer 204 during the execution of the print processing, and a fault diagnosis is made. The steps described in the flowchart are stored in the storage unit of any one of the RAM 303, the ROM 302, and the HDD 304 of the information processing controller unit 201, and are executed by the CPU 301. The flow of the processing describes the flow of print processing in a case where the job control module 401 receives a print instruction from the operation unit I/F 306.

In an image generation processing step S601, the job control module 401 causes the image processing unit 307 to perform processing for converting print data described in page description language (PDL) and so on into image data in a form that the printer 204 can interpret.

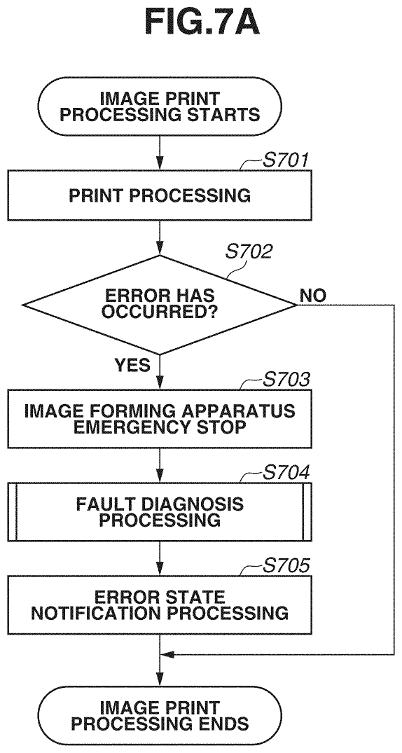

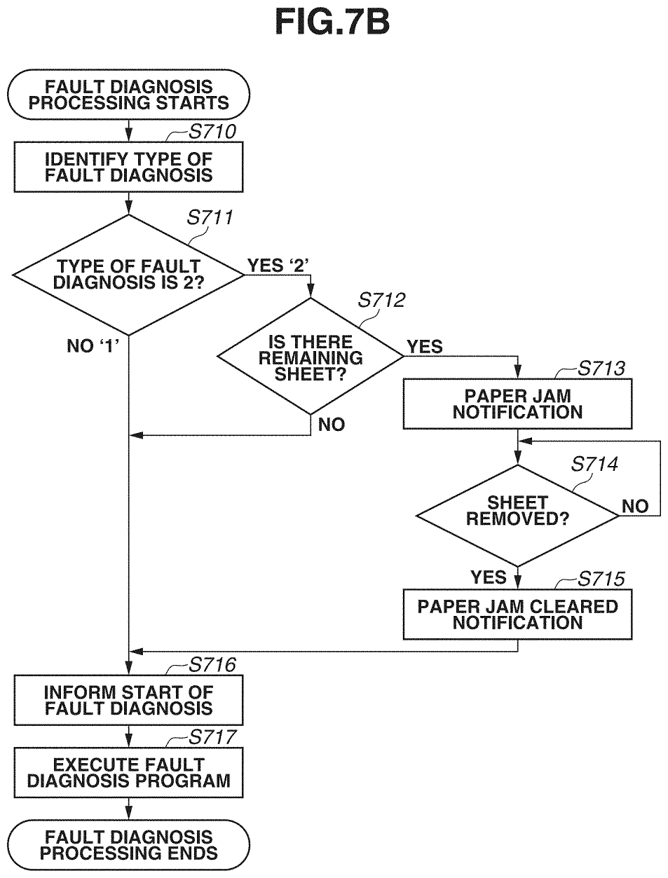

In the subsequent image print processing step S602, the job control module 401 requests the device controller I/F control module 404 to perform print processing for the image. The device controller I/F control module 404 requests the printer controller unit 202 to perform print processing for the image. The flow of processing in the printer controller unit 202 performed in step S602 is described below with reference to FIGS. 7A and 7B.

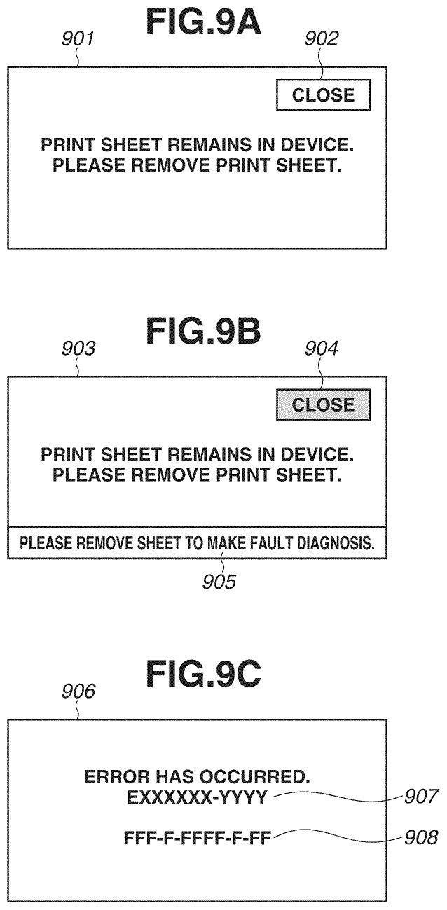

In the subsequent step S603, the job control module 401 receives, from the device controller I/F control module 404, a result of the print processing, an event of paper jam detection, an event of the occurrence of an error, and so on. The job control module 401 requests the operation unit control module 403 to generate a screen in accordance with the content of the event thus received, and the operation unit control module 403 displays the screen in the display unit of the operation unit 206 via the operation unit I/F 306. The details of step S603 will be described below with reference to FIGS. 9A to 9C.

### (Image Print Processing: Printer Controller Unit)

The details of the flow of the image print processing executed in the printer controller unit 202 in step S602 will be described with reference to FIGS. 7A and 7B. The flowcharts shown in FIGS. 7A and 7B are stored in the storage unit of either one of the RAM 312 and the ROM 311 of the printer controller unit 202, and are executed by the CPU 310.

In step S701, the execution processing module 408 requests the printer 204 to execute the print processing.

In step S702, the execution processing module 408 determines whether an error has occurred as a result of the print processing in step S701. If no error has occurred (NO in step S702), then the image print processing is finished. On the other hand, if an error has occurred (YES in step S702) as a result of the determination in step S702, the processing proceeds to step S703, and the image forming apparatus is brought to an emergency stop.

Next, in order to identify a cause of the error, in step S704, the fault diagnosis processing module 409 performs fault diagnosis processing. The details of the fault diagnosis processing in step S704 will be described below with reference to FIG. 7B. After the fault diagnosis processing is completed in step S704, the processing proceeds to step S705, in which the execution processing module 408 informs the job control module 401 of an error state via the device controller I/F control module 404, and the flow of the image print processing ends.

### (Fault Diagnosis Processing: Printer Controller Unit)

Next, the details of the fault diagnosis processing in step S704 of FIG. 7A are described with reference to FIG. 7B. The fault diagnosis processing is executed by the fault diagnosis processing module 409 of the printer controller unit firmware 407.

First, in step S710, a type of fault diagnosis is identified on the basis of the error which has occurred in the print processing of step S701. Table 1 shows one example of a correspondence relationship between an error code related to the error which has occurred in the print processing of step S701 and the type of fault diagnosis.

The type of fault diagnosis is the following two types. The type of fault diagnosis is determined to be a type ‘1’ in a case where the fault diagnosis can be made with a print sheet remaining in the apparatus. The type of fault diagnosis is determined to be a type ‘2’ in a case where the fault diagnosis cannot be made with the print sheet remaining in the apparatus due to a possibility of damage to the print sheet and the apparatus.

Table 1 indicates, for example, that the type of fault diagnosis is determined to be ‘2’ in a case where a fault corresponding to an error code ‘E006’ occurs.

TABLE 1

| Error | Type of fault | |
|---|---|---|
| code | diagnosis | Content of abnormality detected |
| E001 | 1 | Abnormality of toner density in developing unit |
| | | (yellow) |
| E002 | 1 | Abnormality of toner density in developing unit |
| | | (magenta) |
| E003 | 1 | Abnormality of toner density in developing unit |
| | | (cyan) |
| E004 | 1 | Abnormality of toner density in developing unit |
| | | (black) |
| E005 | 1 | Abnormality of fan rotation |
| E006 | 2 | Abnormality of intermediate transfer belt |
| | | detaching mechanism |
| E007 | 1 | Abnormality of monochrome drum motor rotation |
| E008 | 1 | Abnormality of color drum motor rotation |
| E009 | 1 | Abnormality of fixing motor rotation |
| • | • | • |

Next, in step S711, the fault diagnosis processing module 409 determines whether the type of fault diagnosis corresponds to ‘2’ on the basis of the type of fault diagnosis determined in step S710.

If the type of fault diagnosis is determined to be ‘1’ (NO in step S711), the processing proceeds to step S716. If the type of fault diagnosis is determined to be ‘2’ (YES in step S711), the processing proceeds to step S712.

In step S712, the fault diagnosis processing module 409 determines whether there is a remaining sheet. If it is determined that no sheet remains (NO in step S712), then the processing proceeds to step S716. If it is determined that a sheet remains in step S712 (YES in step S712), then the processing proceeds to step S713.

In step S713, the fault diagnosis processing module 409 notifies the job control module 401 of identification information showing that the sheet is remaining, and the processing proceeds to step S714.

In the present exemplary embodiment, as the identification information showing that the sheet is remaining, a jam code that is different from a paper jam in a paper path serving as paper passage route in normal printing, is generated and is given as notification. The jam code herein is a code indicating a paper jam state including a location where the paper jam has occurred in the paper path.

The paper jam notification given in a case where the occurrence of an error is detected in step S702 of FIG. 7A and the paper jam has occurred in the paper path of the apparatus when the image forming apparatus is brought to the emergency stop in step S703, is hereinafter referred to as ‘paper jam notification involving a fault diagnosis’.

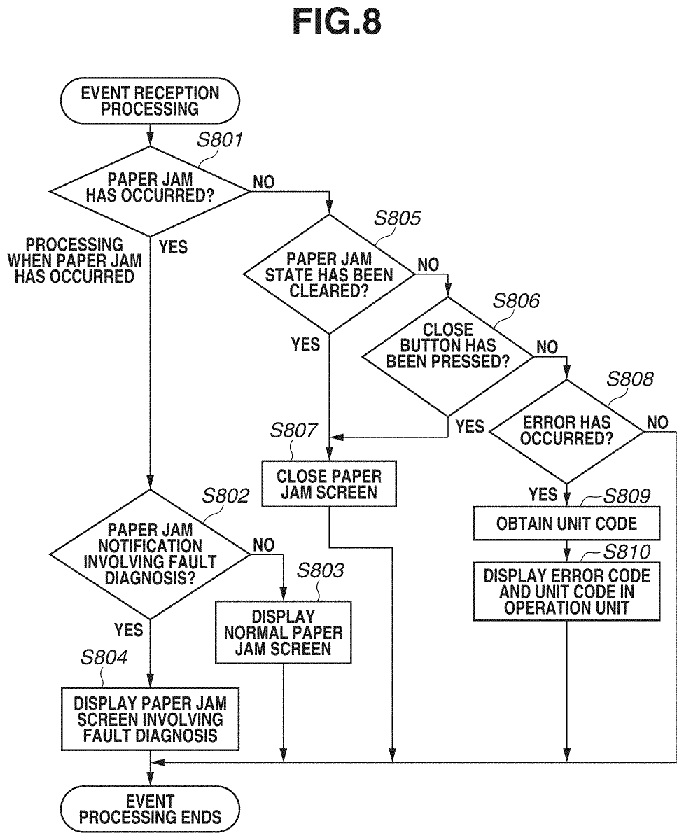

The information processing controller unit 201 receives the ‘paper jam notification involving a fault diagnosis’ from the printer controller unit 202 and displays a paper jam screen as appropriate, and so on. The operation of the information processing controller unit 201 will be described below with reference to FIG. 8.

In step S714, the fault diagnosis processing module 409 waits until the remaining sheet is removed, and if the remaining sheet is removed (YES in step S714), then the processing proceeds to step S715.

In step S715, the information processing controller unit 201 is notified that the paper jam has been cleared. Upon the receipt of the notification, the information processing controller unit 201 clears the paper jam screen, and the processing proceeds to step S716.

If, in step S711, the type of fault diagnosis is determined to be ‘1’ (NO in step S711), and in step S712, no sheet remains (NO in step S712), or if the paper jam has been cleared, then the processing proceeds to step S716. In step S716, the fault diagnosis processing module 409 notifies the information processing controller unit 201 to start a fault diagnosis, and the processing proceeds to step S717.

In step S717, the fault diagnosis processing module 409 executes the fault diagnosis program to identify a location of the fault. More specifically, the printer controller unit 202 diagnoses the printer 204 mechanically or electrically to identify a location of the fault. As a result of execution of the fault diagnosis program, the printer controller unit 202 identifies a location of the fault, record the same as a unit code, in the RAM 312, informs the information processing controller unit 201 of the completion of the fault diagnosis, and then finishes the fault diagnosis processing.

### (Flow of Processing in Job Control Module: Information Processing Controller)

The flow of processing performed in the job control module 401 at a time when an event notified to the information processing controller unit 201 in the flow of processing of FIGS. 7A and 7B or an event of operation on the operation unit 206 is received, will be described with reference to FIG. 8. The processing related to the processing flow is the same as that of step S603 of FIG. 6, is stored in the storage unit of any one of the RAM 303, the ROM 302, and the HDD 304 of the information processing controller unit 201, and is executed by the CPU 301.

[Processing when Paper Jam (No Error) has Occurred]

First, a description is given of the flow of processing in a case where notification of an event that a paper jam has occurred while no error occurs in printing is received from the printer controller unit 202.

In step S801, the CPU 301 determines whether a paper jam has occurred. In a case where the paper jam has occurred in printing (YES in step S801), the printer controller unit 202 notifies a jam code which is paper jam information showing the occurrence of the paper jam.

Subsequently, in step S802, it is determined whether the notification is ‘paper jam notification involving a fault diagnosis’ on the basis of the notified jam code.

In step S802, in a case where the notification is determined not to be ‘paper jam notification involving a fault diagnosis’ (NO in step S802), the processing proceeds to step S803.

In step S803, the information processing controller unit 201 gives an instruction to display a paper jam screen 901 (FIG. 9A, for example) showing a normal paper jam in the display unit of the operation unit 206. The paper jam screen 901 showing the normal paper jam includes a “close” button 902. The button 902 is an instruction portion for deferring the processing for removing a jammed sheet, to allow the use of a function not related to printing. If the “close” button 902 is pressed, the processing for removing the jammed sheet is deferred, so that a function, such as a scan function, which is not related to printing can be used. After that, the flow of the processing is finished.

### [Processing Upon Receipt of Close Button Pressed Event]

A case will be described where the paper jam screen 901 is displaying a normal paper jam in the display unit of the operation unit 206, and in this state, an event that the “close” button 902 as the instruction portion continues to be pressed, is received from the operation unit 206.

In such a case, in the flow of processing of FIG. 8, the processing proceeds to NO in step S801, NO in step S805, and YES in step S806 in response to the pressing of “close” button 902, and proceeds to step S807.

In step S807, the operation unit control module 403 is requested to close the active paper jam screen 901 showing the normal paper jam.

[Processing when Paper Jam Involving Fault Diagnosis has Occurred]

Next, a description is given of the flow of processing at a time when an event that the paper jam involving a fault diagnosis has occurred is received from the printer controller unit 202.

In step S801, it is determined that the paper jam has occurred (YES in step S801) and the processing proceeds to step S802.

In step S802, a determination is made by using a jam code. The jam code is identification information which shows that there is a remaining sheet. With respect to the remaining sheet, the notification is given by the printer controller unit 202 about whether it is ‘paper jam notification involving a fault diagnosis’. If the notification is determined to be ‘paper jam notification involving a fault diagnosis’ (YES in step S802), then the processing proceeds to step S804.

In step S804, the operation unit control module 403 is requested to display a paper jam screen 903 (FIG. 9B, for example) involving a fault diagnosis, and the operation unit control module 403 displays the screen 903 in the display unit of the operation unit 206.

The paper jam screen 903 involving a fault diagnosis changes display of the “close” button 902 arranged in the normal paper jam screen 901, or a button corresponding thereto, which is an instruction portion giving an instruction for deferring processing for removing the jammed sheet. More specifically, as shown in FIG. 9B, a “close” button 904 is grayed out, which does not allow the user to press the “close” button 904. The button itself may not be displayed, i.e., not arranged in order that a function to defer removal of the jammed sheet cannot be executed.

Further, it is possible to display, in a lower part of the paper jam screen for giving paper jam notification involving a fault diagnosis, a message 905 showing the need for removing the jammed sheet in order to make the fault diagnosis.

An effect of displaying the screen is that, differently from a normal paper jam, the user knows the need for clearing the paper jam to make the fault diagnosis, and the user can, therefore, understand that the fault diagnosis is made after the paper jam is cleared, and the continued use is not allowed.

The screen display is made as above described and the flow of processing ends.

[Processing when State of Paper Jam Involving Fault Diagnosis is Cleared]

In a case where the user removes a jammed sheet, in step S715 of FIG. 7B, an event that paper jam cleared notification is given by the printer controller unit 202 and is received by the job control module 401, occurs. In such a case, in the flow of processing of FIG. 8, the processing proceeds to NO in step S801 and YES in step S805, and then proceeds to step S807.

In step S807, the operation unit control module 403 is requested to close the paper jam screen 903 involving a fault diagnosis, and the flow of processing ends.

[Processing when Fault Diagnosis is Completed]

Next, a description is given of the flow of processing in a case where, when the fault diagnosis is completed, event notification to that effect is received from the printer controller unit 202. When the fault diagnosis is completed, in the flow of processing of FIG. 8, the processing proceeds to NO in step S801, NO in step S805, and NO in step S806, and then proceeds to step S808.

In step S808, the determination is YES because an error code is given in notification at a time when notification of completion of fault diagnosis in step S705 is given, and the processing proceeds to step S809.

In step S809, the job control module 401 obtains the unit code 501 related to an error from the printer controller unit 202 via the device controller I/F control module 404. Alternatively, the unit code 501 may be returned along with the completion of the flow of processing of FIG. 7A.

In step S810, an error screen 906 (FIG. 9C, for example) is displayed in the display unit of the operation unit 206 based on the error code 907 and the unit code 908 obtained in step S809, and the flow of processing ends.

In the foregoing flow of processing, in a case where the paper jam involving the fault diagnosis caused by an emergency stop of a device when an error has occurred, identification information is given which shows the presence of the remaining sheet different from that in the normal paper jam. Further, in a case where the paper jam involving the fault diagnosis occurs, by switching of a user interface (UI) control in accordance with the identification information showing the presence of the remaining sheet, a display is made in a UI in order to quickly remove the sheet. Since the UI display shows that removal of a sheet is necessary to make the fault diagnosis, the user can understand that the fault diagnosis is made after the paper jam is cleared, and the continued use is not allowed. This reduces the confusion of the user about operation after the paper jam is cleared.

Hereinafter, a second exemplary embodiment is described. In the first exemplary embodiment, the multifunction peripheral 120 is brought to an emergency stop in response to the occurrence of an error, and consequently, the paper jam screen 903 involving a fault diagnosis is displayed at a time when a paper jam has occurred. After the paper jam is cleared, the fault diagnosis is made, and when the fault diagnosis is finished, an error code and a unit code are displayed in the display unit of the operation unit 206. In the second exemplary embodiment, the flow of control processing is described in which an error screen is displayed immediately after the occurrence of an error, then the image forming apparatus is brought to an emergency stop, and the paper jam screen is displayed. The second exemplary embodiment focuses on points that are different from the first exemplary embodiment, and a description of flow that is similar to that in the first exemplary embodiment is omitted.

In the second exemplary embodiment, as for the flow of processing in the information processing controller unit 201 in a case where the multifunction peripheral 120 starts print processing, an error occurs in the printer 204 during the print processing, and the fault diagnosis is made, the description of the flow is omitted because the flow of processing is similar to that of FIG. 6.

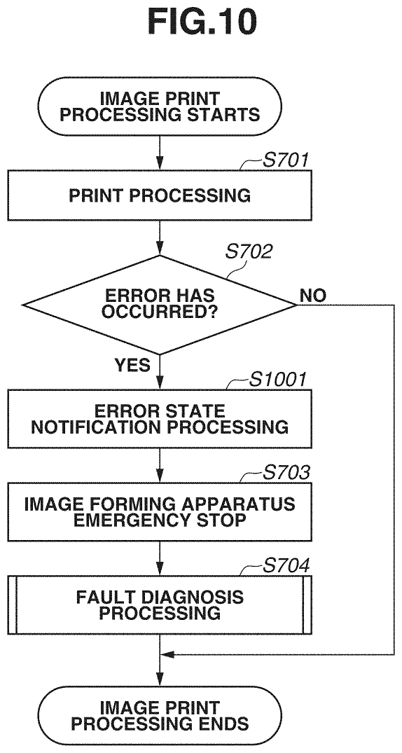

The flow of processing corresponding to FIG. 7A in the first exemplary embodiment will be described with reference to a flowchart of FIG. 10. The processing described in the flowchart of FIG. 10 is stored in the storage unit of either one of the RAM 312 and the ROM 311, and is executed by the CPU 310 of the printer controller unit 202.

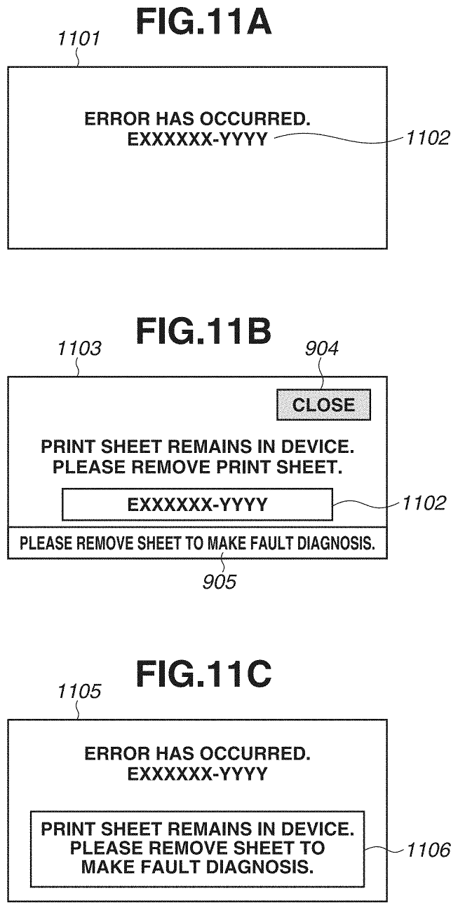

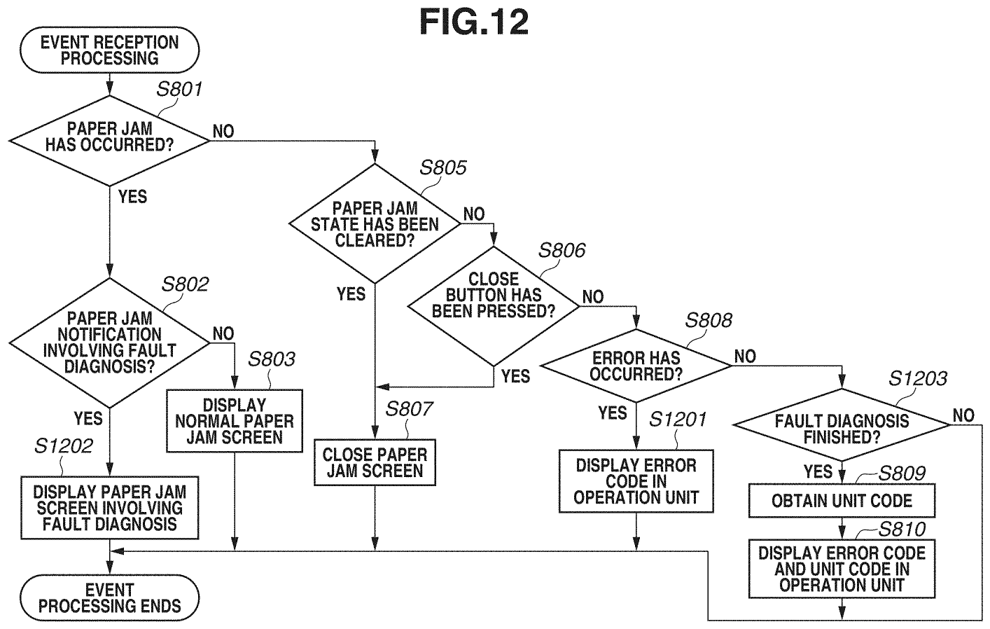

The flow of FIG. 10 is different from the flow of FIG. 7A in the following points. In step S702, in a case where it is determined that an error has occurred (YES in step S702), first, in step S1001, error state notifying processing is executed. The job control module 401 receives the error state notification, and requests the operation unit control module 403 to display an error screen 1101 including an error code 1102 (FIG. 11A, for example) in the display unit of the operation unit 206 (step S1201 of FIG. 12).

The description of the subsequent image forming apparatus emergency stop (step S703) and the fault diagnosis processing (step S704) is omitted because the processing thereof is similar to that in the first exemplary embodiment.

Next, the description is given, with reference to FIG. 12, of the processing corresponding to FIG. 8 of the first exemplary embodiment. The flow described in FIG. 12 is the processing in step S603 of FIG. 6, and is stored in the storage unit of any one of the RAM 303, the ROM 302, and the HDD 304, and is executed by the CPU 301 of the information processing controller unit 201.

[Processing when Error has Occurred]

When an event occurs that an error state is notified in the error state notifying processing of step S1001 of FIG. 10 and the information is received by the information processing controller unit 201, in the flow of processing of FIG. 12, the processing proceeds to NO in step S801, NO in step S805, and NO in step S806, and then proceeds to step S808.

In step S808, a determination of YES is made because an error has occurred, and the processing proceeds to step S1201.

Subsequently, in step S1201, the job control module 401 requests the operation unit control module 403 to display the error screen 1101 including error information related to an error code given in the error state notifying processing of step S1001. The event processing is then finished.

[Processing when Paper Jam Involving Fault Diagnosis has Occurred]

In the print processing (step S701) of the flow of processing in FIG. 10, when an error has occurred (YES in step S702), an error state is notified immediately thereafter in the error state notifying processing (step S1001), and the image forming apparatus is brought to an emergency stop state (step S703), which causes a paper jam. The subsequent fault diagnosis processing in step S704 is described with reference to FIG. 7B.

In this case, clearing of the paper jam is necessary to make a fault diagnosis (YES in step S711, and YES in step S712), and a jam code related to the paper jam is notified in the subsequent paper jam notification of step S713. The jam code in such a case is notified as a jam code different from that of a normal paper jam.

Then, the information processing controller unit 201 receives an event of the paper jam notification, and the processing proceeds to the flow of processing of FIG. 12. Since the paper jam has occurred, the processing proceeds to YES in step S801, and ‘paper jam notification involving a fault diagnosis’ is determined by the information processing controller unit 201 that has received the paper jam notification with the jam code, in step S802 (YES in step S802), and then the processing proceeds to step S1202.

In step S1202, a paper jam screen involving a fault diagnosis is displayed in the display unit of the operation unit 206.

One example of a paper jam screen 1103 involving a fault diagnosis (FIG. 11B, for example) is shown. The paper jam screen 1103 is different from the paper jam screen 903 of the first exemplary embodiment in that an error code 1102 is displayed in the paper jam screen. The paper jam screen 1103 is similar to that of the first exemplary embodiment in that the “close” button 904 is displayed in gray, which does not allow the user to press the button, or the “close” button is not displayed, or provided. As with the first exemplary embodiment, the paper jam screen 1103 may display, in a lower part thereof and so on, notification 905 that clearing of the paper jam is necessary in order to make a fault diagnosis.

Further, in the foregoing description, the paper jam screen is displayed as soon as the paper jam is notified. Instead of this, however, it is possible to keep the error screen as-is because of the error occurrence state, and display the paper jam screen in response to pressing of a button in the error screen. One example of an error screen 1105 in such a case is shown (FIG. 11C, for example). The error screen 1101 is displayed before the paper jam notification; however, in response to the received paper jam notification, in the error screen 1105, a message that a paper jam is occurring and removing of the print sheet is necessary to make a fault diagnosis, is displayed on the button 1106. By pressing the button 1106, the paper jam screen 1103 may be displayed.

[Processing when Fault Diagnosis is Completed]

A description will be given, with reference to FIG. 12, of the flow of processing for a case where the completion of fault diagnosis processing described in FIG. 10 is notified to the information processing controller unit 201. When the job control module 401 of the information processing controller unit 201 receives the notification of the completion of fault diagnosis, the flow of the event reception processing of FIG. 12 is executed. When the fault diagnosis is completed, the determination is NO in steps S801, S805, S806, and S808. In step S1203, it is determined whether the fault diagnosis is finished, and the determination is YES, and then the processing proceeds to step S809 to obtain unit code information. In step S810, an error screen including an error code and a unit code is displayed in the display unit of the operation unit 206. The detailed description of steps S809 and S810 is omitted because the description thereof is provided in the first exemplary embodiment.

In the foregoing flow of processing, also in the case of displaying an error screen along with the occurrence of an error, if a paper jam involving a fault diagnosis caused by an emergency stop of a device has occurred, identification information is given which shows the presence of a remaining sheet different from that in a normal paper jam. Further, in a case where a paper jam involving a fault diagnosis has occurred, by switching of a UI control in accordance with the identification information showing the presence of a remaining sheet, the control method of the UI is changed such that the sheet is quickly removed. Further, by indicating that removal of a sheet is necessary to make a fault diagnosis in the UI display, the user can understand that the fault diagnosis is made after the paper jam is cleared, and the continued use is not allowed. This reduces the confusion of the user about operation after the paper jam is cleared.

In the foregoing exemplary embodiments, in the paper jam screens 903 and 1103 involving a fault diagnosis that prompt the user to remove a sheet, buttons to close the paper jam screens 903 and 1103 are not displayed or are blacked out. Instead of this, in another aspect, a close button is displayed in the screen to allow the user to press the button to close the screen, and pressing of the close button displays a message to the effect that diagnosis processing cannot be made.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may include one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2019-058732, filed Mar. 26, 2019, which is hereby incorporated by reference herein in its entirety.

What is claimed is:

1. An image forming apparatus comprising:
a display unit;
a processor and a memory storing instructions that, when the instructions are executed by the processor, cause the image forming apparatus to perform operations including:
displaying, in the display unit, a screen including a message for prompting removal of a sheet remaining in a paper path of the image forming apparatus,
wherein, when the screen is displayed in a case where diagnosis processing is required on a detected abnormality, the screen does not include an instruction portion that allows the screen to be closed without removing the sheet, and
wherein, when the screen is displayed in a case where the diagnosis processing is not required, the screen includes the instruction portion that allows the screen to be closed without removing the sheet; and
performing the diagnosis processing, in response to a detection of removal of a sheet remaining in a paper path of the image forming apparatus in the case where the diagnosis processing is required.

2. The image forming apparatus according to claim 1, wherein, when the screen is displayed in the case where the diagnosis processing is required, the screen includes a message that indicates need for removal of the sheet in order to perform the diagnosis processing.

3. The image forming apparatus according to claim 1, wherein the instructions further cause the information processing apparatus to display, in the display unit and immediately after an abnormality occurs, another screen including a message about the detected abnormality.

4. An image forming apparatus comprising:
a display unit;
a processor and a memory storing instructions that, when the instructions are executed by the processor, cause the image forming apparatus to perform operations including:
displaying, in the display unit, a first screen including a message for prompting removal of a sheet remaining in a paper path of the image forming apparatus,
wherein, when the screen is displayed in a case where diagnosis processing is required on a detected abnormality, the screen includes an instruction portion that allows the screen to be closed without removing the sheet, and further includes a message indicating that if the instruction portion is used, the diagnosis processing cannot be performed; and
performing the diagnosis processing, in response to a detection of removal of a sheet remaining in a paper path of the image forming apparatus in the case where the diagnosis processing is required.

5. The image forming apparatus according to claim 4, wherein control is performed such that, immediately after an abnormality occurs, another screen including a message about the detected abnormality is displayed in the display unit.

6. A method for an image forming apparatus having a display unit, the method comprising:
displaying, in the display unit, a screen including a message for prompting removal of a sheet remaining in a paper path of the image forming apparatus,
wherein, when the screen is displayed in a case where diagnosis processing is required on a detected abnormality, the screen does not include an instruction portion that allows the screen to be closed without removing the sheet, and
wherein, when the screen is displayed in a case where the diagnosis processing is not required, the screen includes the instruction portion that allows the screen to be closed without removing the sheet; and
performing the diagnosis processing, in response to a detection of removal of a sheet remaining in a paper path of the image forming apparatus in the case where the diagnosis processing is required.

7. A method for an image forming apparatus having a display unit, the method comprising:
displaying, in the display unit, a first screen including a message for prompting removal of a sheet remaining in a paper path of the image forming apparatus,
wherein, when the screen is displayed in a case where diagnosis processing is required on a detected abnormality, the screen includes an instruction portion that allows the screen to be closed without removing the sheet, and further includes a message indicating that if the instruction portion is used, the diagnosis processing cannot be performed; and
performing the diagnosis processing, in response to a detection of removal of a sheet remaining in a paper path of the image forming apparatus in the case where the diagnosis processing is required.
